(19) United States
(12) Patent Application Publication
(10) Pub. No.: US 2006/0124805 A1
(43) Pub. Date: Jun. 15, 2006

(54) Display support

(75) Inventor: Ming-Hsien Huang, Sijhih City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/297,738

(22) Filed: Dec. 8, 2005

(30) Foreign Application Priority Data
Dec. 15, 2004 (TW) 93139027

(51) Int. Cl. A47G 29/00; F16M 13/00

(52) U.S. Cl. 248/125.1; 248/371; 361/681; 361/683

(57) ABSTRACT

A display support used for supporting a display is provided. The support at least includes a base, an engaging apparatus and a connecting rod. The base has a pivot, and the engaging apparatus has a hook. One end of the engaging apparatus is mounted on the pivot, and the other end of the engaging apparatus protrudes from the base. The connecting rod has a catch portion for catching the hook of the engaging apparatus. The connecting rod with compressibility and extendibility is able to present a compressing state and an extending state. When an external force is applied to the engaging apparatus, the engaging apparatus rotates around the pivot and enables the hook to be separated from the catch portion so as to switch the compressing state and the extending state of the connecting rod.

This application claims the benefit of Taiwan application Serial No. 093139027, filed Dec. 15, 2004, the subject matter of which is incorporated herein by reference.

### BACKGROUND OF THE INVENTION

1. Field of the Invention

The invention relates in general to a display support, and more particularly to a display support having an engaging apparatus whose hook is used to switch the compressing state and the extending state of the display support.

2. Description of the Related Art

A display support with compressibility and extendibility has the advantage of saving both packaging cost and transportation cost. According to the prior art, the display support with compressibility and extendibility switches the compressing state and the extending state of the support by applying a force to a button. However, it is not handy for the user to push the button, especially a small button, for switch the compressing and the extending states of the display support.

### SUMMARY OF THE INVENTION

It is therefore the object of the invention to provide a display support, which switches the compressing state and the extending state of the display support by applying a force to an engaging apparatus having a hook, thus resolving the difficulty in applying a force to a small button of the conventional display support.

According to an object of the invention, a display support used for supporting a displaying panel is provided. The support at least includes a base, an engaging apparatus and a connecting rod. The base has a pivot, and the engaging apparatus has a hook. One end of the engaging apparatus is mounted on the pivot, and the other end of the engaging apparatus protrudes from the base. The connecting rod has a catch portion for catching the hook of the engaging apparatus. The connecting with compressibility and extendibility is able to present a compressing state and an extending state. When an external force is applied to the engaging apparatus, the engaging apparatus rotates around the pivot and enables the hook to be separated from the catch portion so as to switch the compressing state and the extending state of the connecting rod. The engaging apparatus returns to its original position when the external force vanishes. The engaging apparatus preferably includes a rotation spindle and a handle. The rotation spindle is mounted on the pivot, and the handle is connected to the rotation spindle. The hook is preferably disposed at one end of the handle, and the other end of the handle is projected beyond the base. Besides, the display support preferably includes an elastic component with one end connected to the engaging apparatus. When the external force is applied to the engaging apparatus, the elastic component compressed or extended by the engaging apparatus generates an elastic recovery force. When the external force vanishes, the elastic recovery force enables the engaging apparatus to return to the original position.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a diagram showing a display support according to an embodiment of the invention, which the display support is in a compressing state; and

FIG. 1B and FIG. 1C are diagrams showing the display support of FIG. 1A in an extending state.

### DETAILED DESCRIPTION OF THE INVENTION

The invention provides an engaging apparatus disposed in a display support. The display support includes a connecting rod, and the connecting rod has a compressing state and an extending state. One end of the engaging apparatus protrudes from the base of the display support. A hook of the engaging apparatus is used for clipping the catch portion of the connecting rod. When an external force is applied to the engaging apparatus, the engaging apparatus rotates and enables the hook to be separated from the catch portion so as to switch the compressing state and the extending state of the connecting rod. The invention is exemplified by a preferred embodiment, but is not limited thereto.

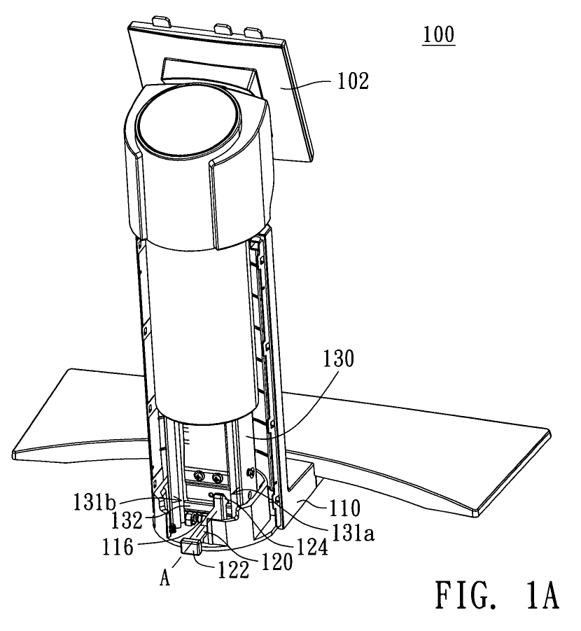

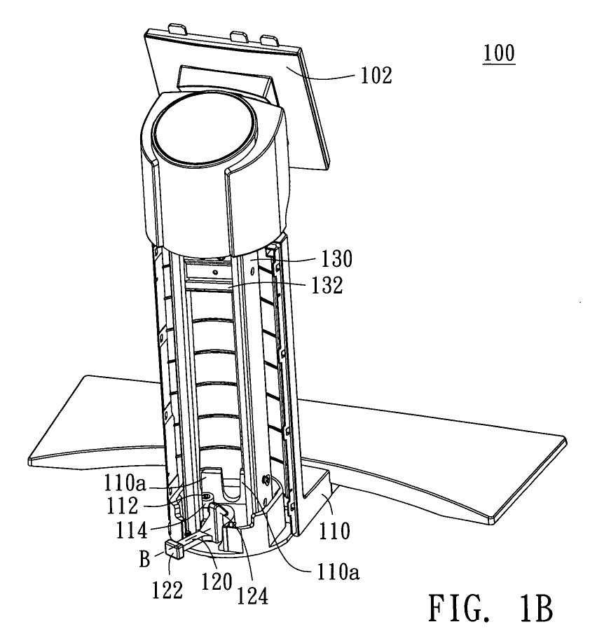

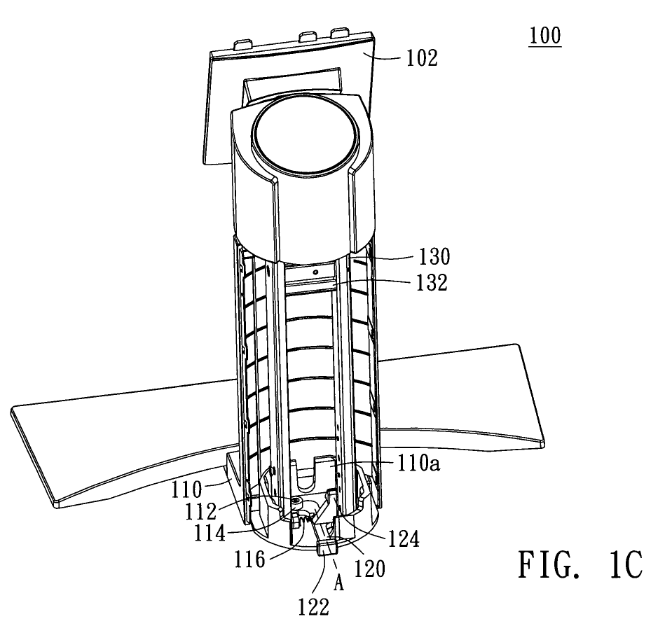

FIG. 1A is a diagram showing a display support according to an embodiment of the invention, which the display support is in a compressing state. FIG. 1B and FIG. 1C are diagrams showing the display support of FIG. 1A in an extending state. A display support 100 includes a tray 102, a base 110, a pivot 112, an engaging apparatus (having a rotation spindle 114 and a handle 120), and a connecting rod 130. A displaying panel is mounted on the tray 102, which enables the display support 100 to support the displaying panel. According to the embodiment, the base 110 has a base wall 110a, vertically disposed on the base 110. The base wall 110a is preferably formed in one piece with the base 110. The pivot 112 is disposed on the base 110, and the rotation spindle 114 is mounted on the pivot 112. The handle 120 is connected to the rotation spindle 114. The handle 120 and the rotation spindle 114 can be formed according to one-piece molding method. Two ends of the handle 120 respectively have a protruding portion 122 and a hook 124, and the protruding portion 122 is projected beyond the base 110.

The connecting rod 130 has a catch portion 132 whose two ends are connected to the sidewalls 131a and 131b of the connecting rod 130. The hook 124 on the handle 120 is used for catching the catch portion 132. The connecting rod 130 with compressibility and extendibility is able to present a compressing state and an extending state. In this embodiment, an elastic component 116 such as a spring is preferably equipped in the display support. One end of the elastic component 116 is connected to the engaging apparatus (such as the handle 120), and the other end is connected to a sidewall of the connecting rod 130 (such as the sidewall 131b of FIG. 1A) or the base wall 110a of the base 110. When an external force is applied to the protruding portion 122, the elastic component 116 is compressed or extended to generate an elastic recovery force. Moreover, the rotation spindle 114, the handle 120, the hook 124 and the protruding portion 122 are preferably formed in one piece.

After the display support is assembled, the handle 120 can be set at a first position A (as shown in FIG. 1A) and a second position B (as shown in FIG. 1B), and moved therebetween. Originally, the handle 120 is positioned at the first position A while no external force is applied to the handle 120. When an external force is applied to the protruding portion 122, the handle 120 can be rotated around the pivot 112 and moved towards the second position B from the first position A. In the embodiment, since two ends of the elastic component 116 are respectively connected to the handle 120 and the sidewall 131b of the connecting rod 130, the elastic component 116 is simultaneously compressed as the handle 120 is rotated. When the handle 120 is moved to the second position B, the compressed elastic component 116 generates an elastic recovery force. When the external force is off, the elastic recovery force of the elastic component 116 enables the handle 120 to rotate around the pivot 112 and return to the first position A from the second position B.

Referring to FIG. 1A, when the handle 120 is positioned at the first position A and the connecting rod 130 presents the compressing state, the hook 124 clips the catch portion 132 for maintaining the connecting rod 130 in the compressing state. If the user would like to unfold the display support, an external force can be applied to the protruding portion 122 to move the handle 120 from the first position A to the second position B; meanwhile, the hook 124 is separated from the catch portion 132. Referring to FIG. 1B, when the handle 120 is positioned at the second position B, the catch portion 132 is no longer restrained by the hook 124, so that the connecting rod 130 can be extended to the extending state. Therefore, by moving the handle 120, the hook 124 and the catch portion 132 can be jointed together or separated from each other, so that the compressing state and the extending state of the connecting rod 130 can be optionally switched. Referring to FIG. 1C, after the connecting rod 130 is extended to the extending state, the external force can be relieved from the protruding portion 122, and the handle 120 is rotated around the pivot 112 and back to its original position. Accordingly, the handle 120 returns to the first position A while the connecting rod 130 is in the extending state, as shown in FIG. 1C.

Although the embodiment is exemplified by connecting two ends of the elastic component 116 respectively to the handle 120 and the sidewall 131b, anyone who is skilled in the technology will understand that the other end of the elastic component 116 can be connected to somewhere else such as the basewall 110a for instance. It is an applicable embodiment of the invention as long as the elastic recovery force of the elastic component 116 can be generated due to the position switch of the handle 120.

Alternatively, if two ends of the elastic component 116 are respectively connected to the handle 120 and the basewall 110a, the elastic component 116 still can be extended and generate an elastic recovery force when the handle 120 is rotated from the first position A to the second position B. The extended elastic component 116 naturally pushes the handle 120 back to the first position A from the second position B when the external force is relieved from the handle 120.

According to the aforementioned description, the display support disclosed in the embodiment switches the compressing state and the extending state by applying an external force to a handle having a hook. Compared to the conventional way of applying the force on the small button, the handle is mush easier for the user to operate. Besides, the display support of the embodiment provides another type of space utilization, enabling the display support to be more versatile in exterior appearance.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display support used for supporting a displaying panel, the display support comprising:
a base having a pivot;
an engaging apparatus having a hook, one end of the engaging apparatus mounted on the pivot, and the other end of the engaging apparatus protruding from the base; and
a connecting rod having a catch portion, the hook able to catch the catch portion, and the connecting rod presenting a compressing state and an extending state;
when an external force applied to the other end of the engaging apparatus for rotating the engaging apparatus rotates, the hook being separated from the catch portion so as to switch the compressing state and the extending state of the connecting rod.

2. The display support according to claim 1, wherein the engaging apparatus has a first position and a second position, the engaging apparatus is positioned at the first position while the external force is off the engaging apparatus, and the engaging apparatus rotates around the pivot and moves to the second position from the first position while the external force is applied to the engaging apparatus.

3. The display support according to claim 2, wherein the hook clips the catch portion for maintaining the connecting rod in the compressing state when the engaging apparatus is positioned at the first position.

4. The display support according to claim 2, wherein the hook is separated from the catch portion when the engaging apparatus is positioned at the second position, enabling the connecting rod to be extended to the extending state.

5. The display support according to claim 1, wherein the engaging apparatus further comprises:
a rotation spindle mounted on the pivot; and
a handle connected to the rotation spindle, wherein the hook is disposed on one end of the handle, and the other end of the handle has a protruding portion projected beyond the base.

6. The display support according to claim 5, wherein the rotation spindle, the handle, the hook and the protruding portion are formed in one piece.

7. The display support according to claim 5, wherein when the external force is applied to the protruding portion, the handle rotates around the pivot, enabling the hook to be separated from the catch portion so as to switch the compressing state and the extending state of the connecting rod.

8. The display support according to claim 1 further comprising an elastic component whose two ends are respectively connected to the engaging apparatus and the base.

9. The display support according to claim 8, wherein the elastic component is compressed or extended, and generate an elastic recovery force when the external force is applied to the engaging apparatus, and the elastic recovery force enables the engaging apparatus to return to its original position when the external force vanishes.

10. The display support according to claim 8, wherein the elastic component is a spring.

11. The display support according to claim 8, wherein the engaging apparatus returns to its original position when the external force vanishes.

12. A display support used for supporting a displaying panel, the display support comprising:
a base;
a pivot disposed on the base;
a rotation spindle mounted on the pivot;
a handle connected to the rotation spindle, two ends of the handle respectively having a protruding portion and a hook, and the protruding portion projected beyond the base;
a connecting rod having a catch portion, the hook able to catch the catch portion, and the connecting rod presenting a compressing state and an extending state; and
an elastic component with one end connected to the handle;
when an external force applied to the other end of the engaging apparatus for rotating the engaging apparatus rotates, the hook being separated from the catch portion so as to switch the compressing state and the extending state of the connecting rod;
when the external force vanishes, an elastic recovery force of the elastic component enables the handle to return to its original position.

13. The display support according to claim 12, wherein the handle can be set at a first position and a second position, the handle is positioned at the first position while the external force is off the handle, and the handle rotates around the pivot and moves to the second position from the first position while the external force is applied to the protruding portion.

14. The display support according to claim 13, wherein the hook clips the catch portion for maintaining the connecting rod in the compressing state when the handle is positioned at the first position.

15. The display support according to claim 13, wherein the hook is separated from the catch portion when the handle is positioned at the second position, enabling the connecting rod to be extended to the extending state.

16. The display support according to claim 15, wherein the elastic component is compressed or extended when the handle is positioned at the second position, enabling the elastic component to generate the elastic recovery force.

17. The display support according to claim 16, wherein when the external force vanishes, the elastic recovery force enables the handle to rotate around the pivot and move to the first position from the second position.

18. The display support according to claim 12, wherein the rotation spindle, the handle, the hook and the protruding portion are formed in one piece.

19. The display support according to claim 12, wherein the elastic component is a spring.
